(19) United States
(12) Patent Application Publication
(10) Pub. No.: US 2022/0264903 A1
(43) Pub. Date: Aug. 25, 2022

(54) METHOD OF PRODUCING COFFEE TABLETS FOR MAKING COFFEE

(71) Applicants: YURY STALMAKHOV, Minsk (BY); ALEH SENAKOSAU, Minsk (BY)

(72) Inventors: YURY STALMAKHOV, Minsk (BY); ALEH SENAKOSAU, Minsk (BY)

(73) Assignees: NIKOLAI TCHERNIAKOVSKI, MINSK (BY); OBSHCHESTVO S OGRANICHENNOY OTVETSTVENNOSTYU "NTLAB-SC", MOSCOW (RU)

(21) Appl. No.: 17/636,461

(22) PCT Filed: Aug. 18, 2019
(86) PCT No.: PCT/IB2019/056961

§ 371 Date: Feb. 22, 2022

(51) Int. Cl. A23F 5/38; A23P 10/28

(52) U.S. Cl. CPC A23F 5/385; A23P 10/28

(57) ABSTRACT

A method of producing coffee tablets for making coffee from roasted coffee beans and other ingredients, including: roasting and grinding coffee beans to obtain two or three fractions of different granularity, forming a serving dose and feeding ingredients sequentially into a moistened press matrix and mixing them, pressing tablets and simultaneously heating a superficial layer, controlling and packaging tablets. A blend, a roasting degree, a fraction size, weight and density are selected in a coffee tablet in such a manner so that a cup of premium coffee could be brewed at home, in an office, in a car, a train and a plane.

This invention relates to the food industry and may be used in coffee processing lines.

Brewing coffee from high-quality natural ground coffee at home or in a company office is not a guarantee that a coffee brew of a stable high quality will be obtained and, furthermore, it is a labor-intensive process. It is not possible to obtain powder portions having optimal amounts of coffee “by eye”, i.e. without a sufficient experience, and in this case, one needs a dry teaspoon, in addition, charging a powder portion to a coffee cup also poses a problem since in the dispensing process some particles are lost forming waste requiring cleaning. Storing coffee powder in a grinding device or in metal, plastic film, aluminum foil, rigid plastic containers or in special sachets before using it leads to impairment of the powder coffee flavor and aroma and to the reduced beverage quality produced therefrom respectively.

Using coffee tablets in individual packages creates a number of advantages within the framework of the practical use, since it simplifies the dispensing and brewing process and, in this case, a user is provided with an accurately measured product portion which produces a constant composition of a brewed beverage. There is a tendency toward a more extensive use of a tableted natural coffee and coffee brews containing such additional products as sugar, milk, flavorings and other ingredients.

The international application WO/2019/106413 “Methods and Devices for Manufacturing Tablets from Ground Coffee” published 2019 Jun. 6, IPC Class A23F5/12, A23F 5/10, A23F5/02, describes a method of manufacturing tablets for making coffee comprising green coffee beans pre-processing, roasting, roasted coffee beans grinding to a preset degree of fineness and granularity; moistening a powdered product; forming a tablet dose of the moistened powdered product by charging powder into a matrix; heating and pressing a formed dose to produce a tablet having a preselected shape under a pressure not causing the deformation of some coffee particles and exudation of coffee bean oils on the tablet surface; discharging a finished tablet and packaging it.

Disadvantages of this invention reside in the fact that multiple moistening of coffee beans and powder increases moisture content in a tablet above 6-8%, thereby resulting in the growth of fungi and bacteria on the surface thereof and reduced shelf life. In addition, molding tablets from a uniformly ground coffee produces tablets having insufficient strength and textured surface that may lead to cracking and further disintegration thereof.

The European Patent EP1956921 “Process for Preparing Coffee Tablets by Aid of Ultrasound” published 2010 Feb. 12, IPC Class A23F 3/32, A23F5/12 describes a method and a process of the tablet production subject to which energy is supplied to a specified portion of a powdered or granulated coffee product, with an aggregating aqueous product being added to this product before supplying energy, and energy is applied to the product in the form of ultrasound mechanical oscillations so as to achieve adhesion of the product particles to each other.

Disadvantages of this invention resides in the fact that adding up to 8% of water to the to-be-molded tablet will result in the growth of fungi and microorganisms on the surface thereof during storage, while applying energy of ultrasound oscillations to a spring-suspended mold used for forming a tablet will not be able to provide a stable tablet size and thickness therefore will vary.

The European Patent EP2793597 “Method and Apparatus for Making a Tablet of Powdered Products for Espresso Beverage Extraction” published 2013 Mar. 26, MPC Class A23F5/12, describes a method and a device for making coffee tablets.

The method comprises the following stages: a) grounding coffee beans and obtaining powder with a uniform size of particles, b) dispensing powder, c) moistening powder, d) homogenizing a moistened mixture to achieve a uniform moisture content, e) molding tablets by pressing, f) remotely supplying energy by irradiation, g) heating the powder to produce partial sintering of the powder particles to provide strength to the finished tablet. The product is exposed to microwave irradiation having specific rate of about 150 W per 1 g of powdered product and frequency of 2.45 GHz with pulsed duration of not less than 60 seconds.

Disadvantages of this invention include moistening and homogenization of the dose to sinter particles over the entire tablet volume by exposing it to microwave irradiation. This approach requires more complex and costly equipment, as well as additional energy consumption. Furthermore, even partial sintering of particles substantially heats the product, thereby resulting in the loss of coffee flavor and also reduced tablet solubility.

The object of the invention is to provide a method for manufacturing tablets for making high-quality coffee from natural coffee beans with improved flavors of a beverage and convenience of use thereof. A tablet should be dense and strong in order to look “neat”, maintain shape during manufacturing operations, transportation and storage, while it should be incompact and loose to easily dissolve in water in the process of brewing. Furthermore, the tablet will have a long shelf life and good disintegration ability in water.

The method of manufacturing tablets for making coffee according to the proposed invention includes the following operations and conditions for realizing them:
coffee beans are ground separately or sequentially to produce at least two fractions of powder with the particle size in the range of 500-900 μm and less than 200 μm followed by separation of particles by size. It is preferable to produce three fractions with particle size in the range of 500-900 μm, 500-200 μm and particles less than 200 μm;
in case of using two fractions, a tablet dose of a powdered product having weight in the range of 5-12 grams per each tablet: a share of powder with the particle size in the range of 500-900 μm makes up 70-90%, with the particle size in the range of less than 200 μm—10-30%; and in case of three fractions: with the particle size in the range of 500-900 μm—60-70%, with the particle size in the range of 400-200—20-25% and less than 200 μm—5-10%;
a powdered product serving dose is formed by feeding coffee powder doses to the press matrix dispensed using a method selected from the group including as follows: weight-dispensing, volume-dispensing and material feed time-dispensing;
in this case, the following is fed into the press matrix separately and sequentially:
   sprayed portion of liquid;
   50-70% of fine fraction portion;
   100% of a coarse fraction or a mixture of coarse and average fractions;
   50-30% of fine fraction portion;
the powder is mechanically compacted in the press with heating of a tablet superficial layer using one of the methods selected from the group comprising as follows:
   heating the press matrix to 55-85° C.,
   microwave pulsed heating of the tablet superficial layer up to a temperature of 100-180° C. with pulsed duration of 20-60 msec,
   superposing ultrasonic oscillations on the surface of a tablet to be formed in the range exceeding 20 KHz;
visual and instrumental examination of manufactured tablets;
packaging tablets in blisters, bags, boxes or containers and transporting them to a finished products warehouse.

A prototype and the provided methods share the following common features:
pre-processing roasted coffee beans;
grinding coffee beans;
forming a serving dose of the powder product;
moistening a powder charge dose before pressing;
pressing powder with heating thereof and forming a tablet;
packaging the tablet.

The following key distinctions exist between the provided method and the prototype:
coffee beans are ground until at least two powder fractions with the particle size in the range of 500-900 μm and less than 200 μm are produced;
most optimally coffee beans are ground until three fractions are produced: with the particle size in the range of 500-900 μm, 400-200 μm and less than 200 μm;
when forming a serving dose having a total weight in the range of 5-12 grams, the powder fraction with the particle size in the range of 500-900 μm or a mixture of two fractions, 500-900 μm and 400-200 μm, makes up 70-90% by weight, while with particle size in the range of less than 200 μm—10-30%;
a serving dose is formed by feeding a measured dose of powder coffee to the press matrix using a method selected from a group comprising: weight-dispensing, volume dispensing and material feed time-dispensing.
In one of the embodiments of the invention, a serving dose is formed from different fractions and varieties of ground coffee. In this case, it is also possible to add other ground or liquid food ingredients by dispensing them and mixing in the flow and in the process of filling a compression chamber.
In another embodiment of the invention, a sprayed portion of liquid, 50-70% of a portion of fine fraction, 100% of coarse fractions and 50-30% of fine fraction are fed separately or sequentially to the press matrix.
Yet in another embodiment of the invention, a powder fine fraction is mechanically activated and/or ionized in the corona discharge field.
Then, the tablet is formed using a punch and a press matrix with simultaneous heating of the tablet surface. In this case, one of the following three methods is used for superficial heating: 1—electrical heating of the matrix and punch to 55-85° C., 2—microwave pulsed heating of the tablet superficial layer to 100-180° C. with pulse duration of 20-60 msec, 3—superimposing ultrasonic oscillations on the surface of the tablet to be formed in the range exceeding 20 KHz.

Contrary to other conventional methods, in the provided method liquid is added not into the coffee powder, but into the press matrix in which the tablet is formed. The sprayed liquid uniformly moistens the surface and is distributed over walls, bottom and piston of the matrix.

Then, dry coffee powder of the finest fraction, less than 200 μm, which adheres to moist matrix walls and bottoms is fed to the same matrix, thereby forming some kind of a “liner” comprised of fine particles. Then, a coarse part of fraction with the particle size of 900-400 μm is fed into the matrix, i.e. into the ready fine coffee powder “liner”. Then, the remaining fine powder fraction with the particle size less than 200 μm is fed on the top of the coarse fraction surface to form a “cover”. As a result, the coarse powder fraction is surrounded on all sides by the fine fraction as if it is encapsulated. Thus, the matrix is filled sequentially with the following components: 1-3% (by weight of the serving dose) of liquid, 50-70% of the fine powder fraction, 100% of the coarse powder fraction and 30-50% of the fine fraction. The press piston compresses this inhomogeneous mass into a tablet, so that the coarse-pored fraction is located inside, while a dense layer of fine particles surrounds it on the outside. This attributes a “neat” smooth look to the tablet and ensures rapid solubility of even an uncrushed tablet in hot water due to a coarse-pored fraction core thereof (new technical result).

Forming a pressed dense outer layer of the tablet according to this invention, i.e. a “crust” from fine coffee powder also prevents flavors from evaporating from coarse coffee fractions. Due to this, the quality of coffee to be brewed using a tablet will be higher even at lengthy shelf life compared to the coffee brewed using coffee powder with the same shelf life (new technical result).

The important new result resides in the fact that when using a coffee beverage, fine particles precipitate later, at the end of the brewing process and cover coarse particles forming a rather dense and strong layer preventing large particles from entering into a mouth while drinking coffee when tilting a cup in contrast to a conventional method of brewing coffee in a cup and drinking it. This also makes coffee drinking more comfortable (new technical result).

Furthermore, yet another new important result of the invention is that when brewing coffee in a cup, fine particles precipitate later to form a dense layer covering coffee coarse particles preventing permeation of water to the main powder quantity. Drinking slowly coffee brewed from a homogeneous coffee powder fractions leads to coffee re-extraction and coffee flavor deterioration. Using a mixture comprising different coffee particle-size composition in a tablet really facilitates formation of a dense layer of particles at the cup bottom preventing coffee re-extraction and as a result we obtain a high-quality coffee beverage as if automatically without a human involvement (new technical result).

However, in addition to the aforesaid, when the manufacturing process productivity is increased, a temporary “liner” formed from coffee fine particles as the tablet is pressed may partially fracture while the press matrix is filled with coffee coarse particle fraction. To increase the “liner” strength and prevent it from fracturing, the provided method uses mechanical activation of the powder before feeding it to the matrix. Mechanical activation means activation of solid substances by mechanically processing them. Grinding particles in a striking mode results in accumulation of structural defects in a particle and increase in the surface area, thereby affecting chemical activity thereof.

In the provided invention, the inventors used pulverization of the fine fraction directly before feeding it to the press matrix. The thing is that the chemical activity of the chemically activated particles is lost in time since relaxation of electrochemical bonding accumulated in the process of the particle fracturing takes place. Pulverization of the coffee fine fraction in particular directly before feeding to the matrix promotes enhancement of bonding between particles and with the matrix wall. As a result, the “liner” is produced stronger and is less subjected to fracturing when it is filled with the coarse fraction. Due to this, an even and smooth surface of the tablet outer coating is produced after pressing. According to the information available to us, the use of such mechanical activation process for forming a temporary reinforced coating when pressing coffee tablets is not known (new technical result).

It is not always possible to pulverize the fine fraction directly before feeding the powder into the press matrix in the coffee tablet pressing technology. In case a pre-pulverized powder fine fraction is fed to the press matrix to temporary strengthen the “liner” in the provided invention, it is proposed to use another inventive technique. Before feeding the coffee powder fine fraction into the matrix, it is ionized in the corona discharge field. Charged coffee particles rigidly adhere both to each other and to the matrix walls. A stronger liner is produced and it is less subjected to fracturing when coarse fractions are fed into it. Due to this, an even and smooth surface of the tablet outer coating is produced after pressing. According to the prior art information, electrical charging of coffee particles for forming a temporary reinforced coating was not used in the process of pressing (new technical result).

A coffee powder dose to be fed to the press matrix is formed by measuring a portion of each fraction by the method selected from the group comprising the following: weight-dispensing, volume-dispensing and material feed time-dispensing. Therefore, the provided method ensures high stability of the composition of different fractions and coffee varieties in a coffee tablet.

The particle-size composition selected by inventors based on the studies ensures coffee beverage high quality due to an optimal extraction of the aroma, flavor and useful substances from fractions of different size. This composition will be maintained in each tablet. Forming coffee tablets from a dose in which both a particle-size composition and blends of coffee varieties and fractions are strictly observed ensures high quality of the coffee beverage.

Distribution of different coffee fractions selected by tests also increases tablet density by filling spaces between particles of coarse fractions with particles of fine fractions.

Absolutely different methods are used in the conventional tablet pressing technologies. According to them, a mixture of ingredients is preliminary prepared which is then blended and fed to the press matrix to press a tablet from it.

A separate feed of multiple accurately measured different coffee fractions and varieties to the press matrix according to the invention to form a tablet by pressing was not used earlier (new technical result).

In addition, in the process of brewing up coffee by adding hot water, dry coffee particles better sorb water, thereby increasing extraction of useful substances and aroma. Reducing the amount of moisture to moisten coffee powder during pressing reduces the risk of damaging dry tablets by fungi and bacteria for development of which, as is known, a more humid environment is required. Subsequent heating of the tablet surface in the process of pressing allows excess moisture added to the powder at the powder charging stage to be eliminated. As a result, the shelf life of tablets produced by the method provided increases (new technical result).

In addition, except water, acetyl cellulose, chitosan and polyvinyl alcohol solutions may be used as a liquid for moistening the matrix before coffee powder feeding. After pressing, the above dried liquids form a continuous water-soluble edible film on the tablet surface. This film in combination with a dense outer layer of coffee fine fractions prevents not only evaporation of aromatic substances, but also emission of CO₂ from the tablet. Due to this, the shelf life and quality of the coffee beverage brewed from the tablet increase (new technical result).

The liquids used for moistening the matrix, namely, acetyl cellulose, chitosan and polyvinyl alcohol solutions possess antibacterial properties. Since these liquids are sprayed in relatively small quantities, they effect only the tablet superficial layer. These soluble coatings are extensively used to increase the shelf life of food products, primarily, meat and sausage products. However, according to the information available to us, such methods of applying a coating on coffee tablets are not used. As experiments demonstrated, applying a soluble coating on coffee tablets before pressing appeared to be sufficient to prevent fungi and bacteria from growing on the tablets surface for a long period of time. As a result, the shelf life of tablets before formation of white mold on the surface thereof increases at least twofold. In addition, this improves tablet's appearance (new technical result).

Forming a serving dose during the tablet pressing also provides for the possibility of using different ground coffee fractions and varieties and also using other ground or liquid food ingredients (for example, sugar, milk, flavoring agents) in the tablet composition by dispensing them, blending in the material flow and subsequent filling a compression chamber therewith. Therefore, a product in the form of a pressed tablet may be used as a finished product with various properties required by a user. The advantage resides in the fact that an accurately preset product portion is obtained while containing the required proportions of ingredients and constant composition to brew a beverage from them, thereby expanding the product range (new technical result).

Heating the tablet superficial layer is needed to form a dense and stronger layer on the tablet surface, i.e. a “crust” ensuring higher quality and longer product shelf life. The tablet is heated by the method selected from the group comprising as follows: 1—electrical heating of the matrix and punch to 55-85° C., 2—microwave pulsed heating of the tablet superficial layer to 100-180° C. with pulse duration of 20-60 msec, 3—superimposing ultrasonic oscillations on the surface of the tablet to be formed in the range exceeding 20 KHz. Each of the methods has its advantages and disadvantages. The use of ultrasonic oscillations is preferable in terms of the quality-cost criterion. The European Patent EP1956921 [2] discloses the use of ultrasound in the coffee tablet production. However, the disadvantage of the cited invention is addition of up to 8% of water to the to-be-formed tablet which results in development of fungi and microorganisms on the surface thereof during storage, while applying the energy of ultrasonic oscillations to a spring-suspended mold for forming tablets will not ensure stable sizes of tablets—all of them will have different thickness. Contrary to the above described method, subject to the method provided herein, the press with a punch and a matrix is the main tool for forming tablets. In our case, the ultrasound is an auxiliary means required for heating and agglomeration of particles only in the tablet superficial layer. In this embodiment of the present invention, the mechanical press combined with ultrasonic heating and fine fraction agglomeration promotes formation of a stable tablet shape and size, thereby ensuring strength thereof (new technical result).

The aforesaid provides a proof that the cause and effect relationship exists between characteristic features and a new technical result. According to the information available to the applicant, the proposed combination of essential features characterizing the essence of the invention is not known from the prior art, therefore the invention conforms to the “NOVELTY” criterion.

The essence of the claimed invention is not obvious from the prior art for a person skilled in the art. The combination of features characterizing conventional devices does not provide achievement of new properties and only availability of characteristic features allows new properties and a new technical result to be achieved. Thus, the alleged device complies with the patentability requirement for inventive level.

The essence of the invention is illustrated by graphical data:

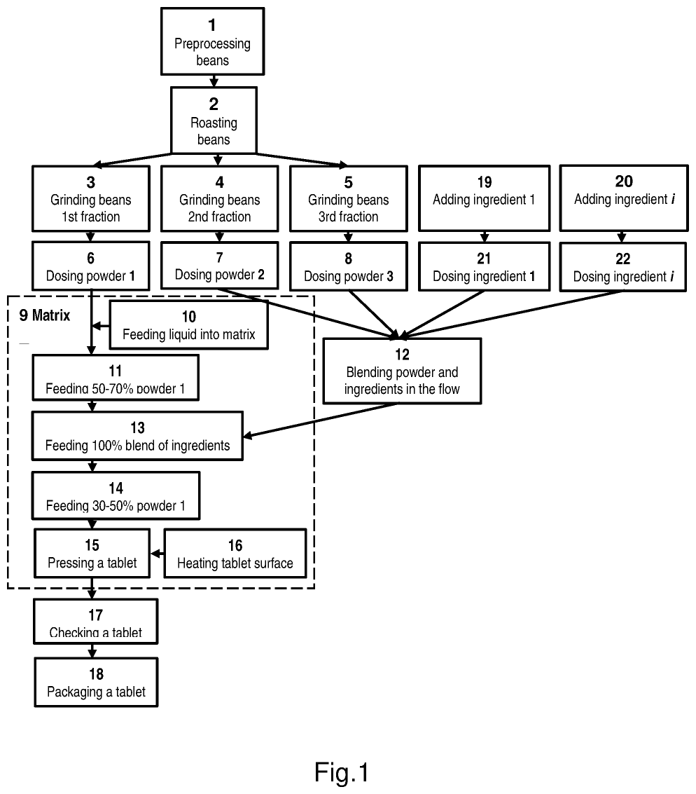

FIG. 1 shows an example and a functional scheme of the tablet fabrication method.
To realize the provided method of producing coffee tablets for making coffee, the following operations are performed:
   Pre-processing green coffee beans
   Roasting coffee beans
   Grinding roasted coffee beans to produce several fractions
   Forming a serving dose and adding ingredients other than coffee
   Feeding separately and sequentially a liquid, coffee fine and coarse fractions and other ingredients
   Blending fractions and ingredients while feeding the material into the press matrix
   Pressing the powder with simultaneous heating to form a tablet
   Packaging the tablet

Referring to FIG. 1, an example shows a tablet process scheme using the following operations:

1. Pre-processing of green coffee beans comprises coffee bean batch control, size-grading (if required), coffee bean flavoring to achieve exclusive aromas (if required).
2. Roasting coffee beans using conventional technologies and preset parameters.
3. Grinding coffee beans to produce 1 powder fraction with the particle size in the range of less than 200 μm.
4. Grinding coffee beans to produce 2 powder fractions with the particle size in the range of 500-200 μm.
5. Grinding coffee beans to produce 3 powder fractions with the particle size in the range of 500-900 μm.

It is noteworthy that each fraction is ground and produced separately or sequentially with size grading.

A serving dose of a tablet weighing in the range of 5-12 grams is formed by dispensing each powder fraction, in case of three fractions, in the following weight doses:
6. For powder 1—less than 200 μm—5-10%;
7. For powder 2—with the particle size in the range of 400-200 μm—20-25%.
8. For powder 3—with the particle size in the range of 500-900 μm—60-70%.

A serving dose of the moistened powder product (tablet) is formed by feeding each coffee powder fraction into the matrix 9 which is measured using any method selected from the group comprising:
weight-dispensing;
volume-dispensing; and
material feed time-dispensing.
9. The following components are separately and sequentially fed into the press matrix 9:
10. A sprayed portion of liquid moistening the matrix surface.
11. 50-70% of the fine fraction portion of the powder 1.
12. Portions of powders 2 and 3 of the medium and coarse fractions are blended in the material flow and then;
13. 100% of the blend is also fed into the press matrix 9.
14. After that, 50-30% of the fine fraction of the powder 1 is also fed into the press matrix 9.
15. The powder is mechanically pressed in a press using the matrix and punch.
16. A tablet superficial layer is heated using any method selected from the group comprising:
   a. electrical heating the matrix and punch up to 55-85° C.;
   b. microwave pulse heating of the tablet superficial layer up to 100-180° C. with pulse duration of 20-60 msec;
   c. superimposing ultrasonic oscillations on the surface of the tablet to be formed in the range exceeding 20 KHz.
17. After pressing and discharging tablets from the matrix 9, the formed tablets are subjected to a visual and instrumental control.
18. After the control, tablets are packaged in blisters, bags, boxes or containers and transported to a finished products warehouse.
19. When producing coffee tablets using the claimed method, other coffee varieties and other ingredients, for example, ingredient 1—sugar, may be added to the tablet.
20. Adding one more ingredient i, for example, milk, promotes expansion of the product range and diversification of taste preferences.
21. These additional ingredients are also dispensed according to properties and required amount thereof.
22. Further, doses of these additional ingredients may be blended with coffee powder coarse fractions in the flow 12.

The use of the provided method of producing tablets for making coffee allows increasing the quality of tablets and coffee brewed therefrom, increase the tablet shelf life and reduce production costs.

In addition, taste properties of a beverage brewed from produced tablets are substantially improved and, hence, opportunities of the use thereof may be substantially expanded.

The claimed method is realized using devices manufactured by the industry and used in the food production. A new positive effect substantiates combination, parameters and succession of operations thereof. Therefore, the claimed method is industrially applicable.

### REFERENCES CITED

1. Application EPO 201891887
2. EP1956921 Process for Preparing Coffee Tablets by Aid of Ultrasound
3. EP2793597 Method and Apparatus for Making a Tablet of Powdered Products for Espresso Beverage Extraction

1. A method of producing coffee tablets for making coffee from roasted coffee beans comprising the following steps:
grinding coffee beans;
forming a tablet dose of a powdered product;
moistening a powdered charge dose and feeding powder to a matrix;
heating and pressing powder to form a tablet; and
packaging the tablet;
characterized in that coffee beans grinding is performed until at least two powder fractions are produced with a degree of fineness within the range of particle sizes from 500 to 900 μm and less than 200 μm to form a tablet dose with the weight of the tablet dose being in the range of 6-12 grams, the powder fraction with the particle size in the range from 500 to 900 μm makes up 70-90% by weight, while the powder fraction with the particle size less that 200 μm makes up 10-30% by weight, with the moistening being performed by preliminary feeding a sprayed portion of liquid to the internal surface of press matrix, followed by sequential feeding of 50-70% of fine fraction, then 100% of coarse-grained fraction and finally 50-30% of fine fraction to the press matrix to form a tablet by pressing using a punch and matrix assembly, while simultaneously superficially heating it, and then the formed tablet is packaged.

2. The method according to claim 1, characterized in that coffee beans grinding is performed until at least three powdered fractions are produced and form a tablet dose with the following fraction ratio: with the particle size in the range of 500-600 μm, 60-70% by weight, with the particle size in the range of 400-200 μm, 25-20% by weight, and with the particle size less than 200 μm, 15-10% by weight, with fractions with the particle size in the range of 500-600 μm and 400-200 μm being mixed before feeding to the matrix.

3. The method according to claim 1, characterized in that forming a tablet dose of different fractions and varieties of ground coffee and also other ground or liquid food ingredients by dispensing and blending them in a flow followed by filling a compression matrix.

4. The method according to claim 1, characterized in that a solution selected from the group comprising acetyl cellulose, chitosan and polyvinyl alcohol (PVA) is used as a liquid solution for preliminary treatment of the matrix.

5. The method according to claim 1, characterized in that before feeding a powder fine fraction to the matrix it is mechanically activated or ionized in the corona discharge field.

6. The method according to claim 1, characterized in that the tablet superficial layer is heated using the method selected from the group comprising:
electrical heating of the matrix and punch to 55-85° C.,
microwave pulsed heating of the tablet superficial layer to 100-180° C. with pulse duration of 20-60 msec,
superimposing ultrasonic oscillations on the surface of the tablet to be formed in the range exceeding 20 KHz.
